(19) United States
(12) Patent Application Publication
(10) Pub. No.: US 2015/0143704 A1
(43) Pub. Date: May 28, 2015

(54) METHOD AND APPARATUS FOR FOLDING KNIFE

(71) Applicant: Victor Lee, New York, NY (US)

(72) Inventor: Victor Lee, New York, NY (US)

(21) Appl. No.: 14/088,467

(22) Filed: Nov. 25, 2013

(51) Int. Cl. B26B 1/04

(52) U.S. Cl. CPC B26B 1/04
USPC 30/161; 29/428

(57) ABSTRACT

A folding knife apparatus including a blade device having a blade with a sharp edge; a sliding device; a stop device; and a housing. The blade device may be connected to the housing so that the blade device rotates with respect to the housing unless prevented by the stop device. The sliding device may be connected to the housing so that the sliding device can slide with respect to the housing. When the sliding device is slid in a first direction, the blade device rotates with respect to the housing from a first state to a second state, wherein in the first state the sharp edge of the blade device is within the housing so that the sharp edge cannot be touched by an individual holding the apparatus, in the second state the sharp edge is outside the housing so that the sharp edge can be touched by the individual.

### FIELD OF THE INVENTION

This invention relates to improved methods and apparatus concerning folding knives.

### BACKGROUND OF THE INVENTION

There are various devices known in the prior art for folding knives.

### SUMMARY OF THE INVENTION

In at least one embodiment, an apparatus or folding knife apparatus is provided comprising a blade device having a blade with a sharp edge; a sliding device; a stop device; and a housing. The blade device may be connected to the housing so that the blade device can rotate with respect to the housing unless prevented by the stop device. The sliding device may be connected to the housing so that the sliding device can slide with respect to the housing. In at least one embodiment, when the sliding device is slid in a first direction, the blade device rotates with respect to the housing from a first state to a second state, wherein in the first state the sharp edge of the blade device is within the housing so that the sharp edge cannot be touched by an individual holding the apparatus, and wherein in the second state the sharp edge of the blade device is outside the housing so that the sharp edge can be touched by the individual holding the apparatus.

The apparatus may further include a first spring device including a spring. In at least one embodiment, the first spring device allows the sliding device to be slid in the first direction when a force is applied to the sliding device in the first direction, but causes the sliding device to slide back in a direction opposite the first direction when the force is no longer applied to the sliding device.

The apparatus may further include a second spring device connected to the blade device. In at least one embodiment, the second spring device causes the sharp edge of the blade device to spring out in response to sliding the sliding device in the first direction. The apparatus may be in the shape of a gun. The housing may include a first plate and a second plate, wherein in the first state, the sharp edge of the blade device is between the first plate and the second plate. The stop device may be part of the first plate. The housing may include a first inner plate, a first outer plate, a second inner plate, and a second outer plate, wherein in the first state, the sharp edge of the blade device is between the first inner plate and the second inner plate. The stop device may be part of the first inner plate.

The blade of the blade device may have a notch; and the apparatus may include a first post which is fixed to the sliding device and inserted into the notch of the blade of the blade device in the first state, so that when the sliding device slides in the first direction, the first post contacts the blade device and causes the blade device to rotate, and causes the first post to come out of the notch of the blade.

In at least one embodiment a method is provide comprising the steps of applying a force in a first direction to a sliding device of a folding knife apparatus to cause the sliding device to move, with respect to a housing to which the sliding device is connected, in the first direction, and to thereby cause a blade device of the folding knife apparatus to rotate, with respect to the housing, from a first state to a second state. The folding knife apparatus may be as previously described. The method may further include removing the force to allow the sliding device to slide back in a direction opposite the first direction, wherein when the force is removed the blade device remains in the second state.

### BRIEF DESCRIPTION OF THE DRAWINGS

FIG. 1A shows a left side view of an apparatus in accordance with an embodiment of the present invention, with the apparatus in a closed state;

FIG. 1B shows a right side view of the apparatus of FIG. 1A, with the apparatus in a closed state;

FIG. 1C shows a top view of the apparatus of FIG. 1A, along with a line AA with the apparatus in a closed state;

FIG. 1D shows a rear view of the apparatus of FIG. 1A, with the apparatus in a closed state;

FIG. 1E shows a bottom view of the apparatus of FIG. 1A, with the apparatus in a closed state;

FIG. 1F shows a front view of the apparatus of FIG. 1A, with the apparatus in a closed state;

FIG. 2 shows a right, front, and bottom perspective view of some of the components of the apparatus of FIG. 1A;

FIG. 3 shows a right, front, and bottom perspective view of the components shown in FIG. 2 assembled together, and a sliding device of the apparatus of FIG. 1A;

FIG. 4 shows a right, front, and bottom perspective view of the sliding device of FIG. 3 placed atop the components of FIG. 2, and with various fasteners for connecting the sliding device to the components of FIG. 2;

FIG. 5 shows a right, front, and bottom perspective view of the components of FIG. 2 assembled together with the sliding device of FIG. 3, together with first and second handle devices, and various further fasteners;

FIG. 6 shows a right, front, and bottom perspective view of the apparatus of FIG. 1A, in a completely assembled state;

FIG. 7 shows a left, front, and bottom perspective view of a first inner plate connected to a first outer plate, along with a blade device;

FIG. 8A shows a right, front, and bottom perspective view of the sliding device of FIG. 3;

FIG. 8B shows a left, front, and bottom perspective view of the sliding device of FIG. 3;

FIG. 8C shows a left, front, and bottom perspective view of the sliding device of FIG. 3;

FIG. 8D shows a right side view of the sliding device of FIG. 3 along with a first device for inserting into a portion of the blade device and a second device for use with a spring device;

FIG. 8E shows a cross sectional slice of the sliding device connected to the first device and the second device, along the line AA of FIG. 10;

FIG. 8F shows a front view of the sliding device of FIG. 3;

FIG. 8G shows a rear view of the sliding device of FIG. 3;

FIG. 9A shows a right, front, and bottom perspective view of the first outer plate of FIG. 7;

FIG. 9B shows a left, front, and bottom perspective view of the first outer plate of FIG. 7, along with a spring;

FIG. 9C shows the spring inserted into a recessed area of the first outer plate of FIG. 7;

FIG. 10A shows a right, front, and bottom perspective view of the first inner plate of FIG. 7;

FIG. 10B shows a left, front, and bottom perspective view of the first inner plate of FIG. 7;

FIG. 11A shows a right, front, and bottom view of the blade device of FIG. 7;

FIG. 11B shows a left, front, and bottom view of the blade device of FIG. 7;

FIG. 12A shows a right, front, and bottom perspective view of a second inner plate of the apparatus of FIG. 1A;

FIG. 12B shows a left, front, and bottom perspective view of the second inner plate of FIG. 12A;

FIG. 13A shows a right, front, and bottom perspective view of a second outer plate of the apparatus of FIG. 1A;

FIG. 13B shows a left, front, and bottom perspective view of the second outer plate of the apparatus of FIG. 1A;

FIG. 14A shows a right, front, and bottom perspective view of the first handle device of FIG. 5;

FIG. 14B shows a left, front, and bottom perspective view of the first handle device of FIG. 5;

FIG. 15A shows a right, front, and bottom perspective view of the second handle device of FIG. 5;

FIG. 15B shows a left, front, and bottom perspective view of the second handle device of FIG. 5;

FIG. 16 shows a right, front, and bottom perspective view of the second inner plate of FIG. 12A without a spring;

FIG. 17A shows a right side view of the sliding device in transparent format, the blade device, the second inner plate, and various other components of the apparatus of FIG. 1A, in a first state, where a blade of the blade device is retracted;

FIG. 17B shows a right side view of the sliding device in transparent format, the blade device, the second inner plate, and various other components of the apparatus of FIG. 1A, in a second state, where a blade of the blade device is in an expanded or opened state;

FIG. 17C shows a right side view of the sliding device in transparent format, the blade device, the second inner plate, and various other components of the apparatus of FIG. 1A, in a third state, where a blade of the blade device is expanded or opened and the sliding device has returned to its position of FIG. 17A; and

FIG. 18 shows a right side view of the sliding device separated from other components of the apparatus of FIG. 1A, with the blade device shown in an expanded or opened state.

### DETAILED DESCRIPTION OF THE DRAWINGS

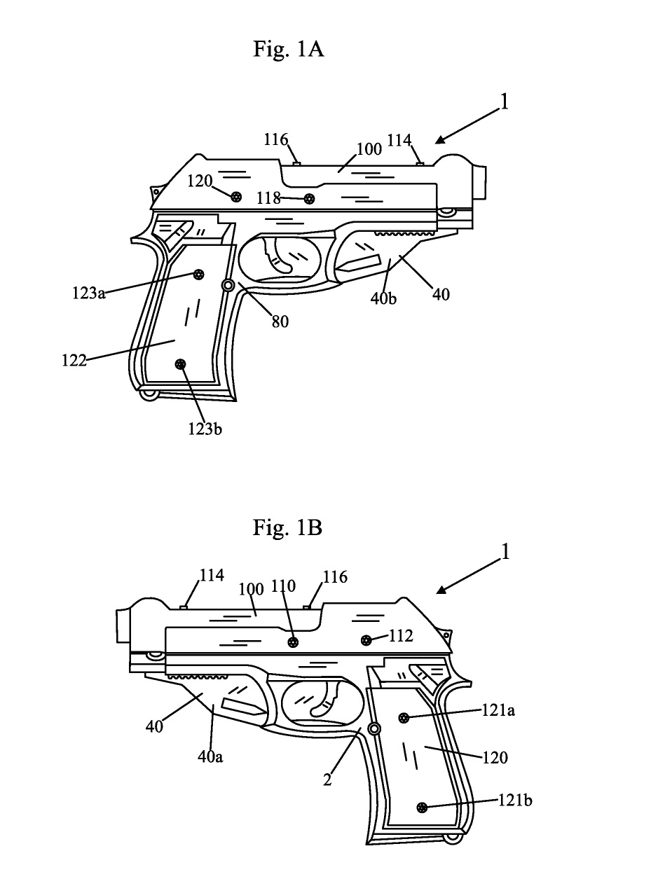

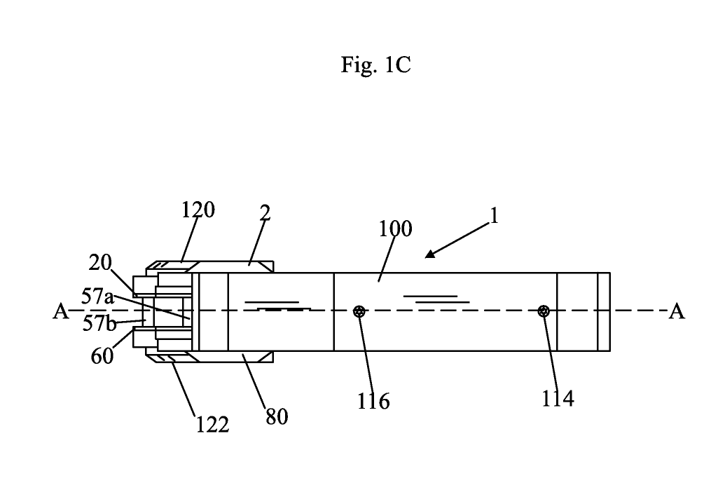

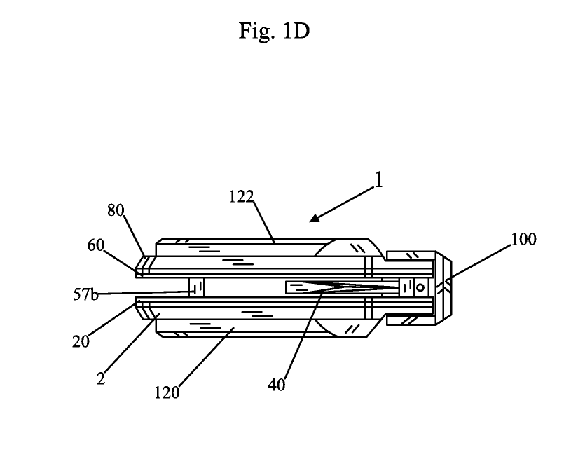

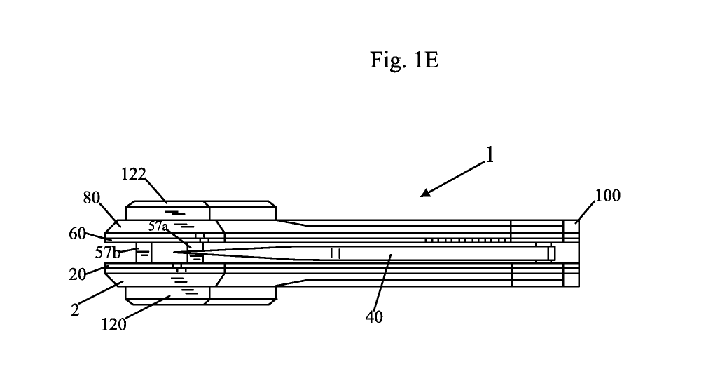

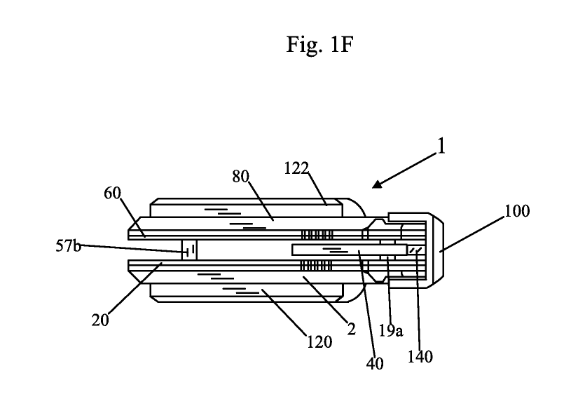

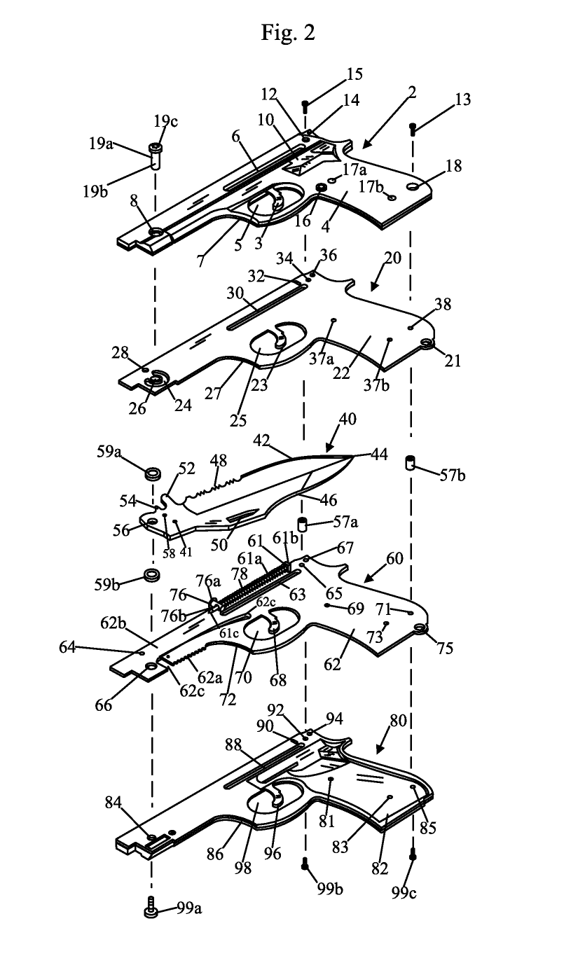

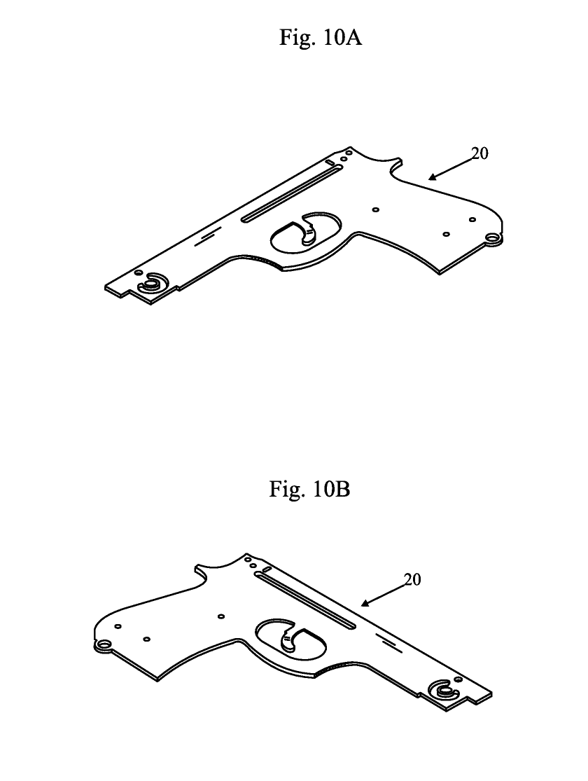

FIGS. 1A, 1B, 10, 1D, 1E, and 1F show left side, right side, top, rear, bottom, and front views of an apparatus 1 in accordance with an embodiment of the present invention. FIG. 2 shows a right, front, and bottom perspective view of some of the components of the apparatus 1.

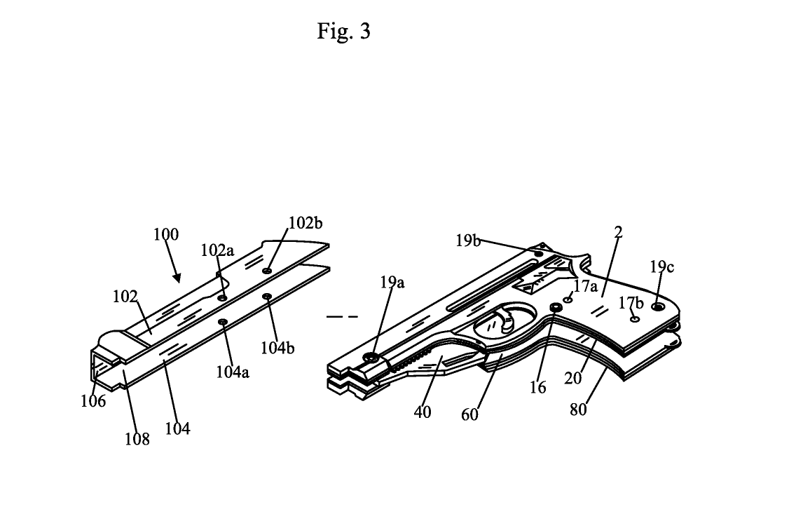

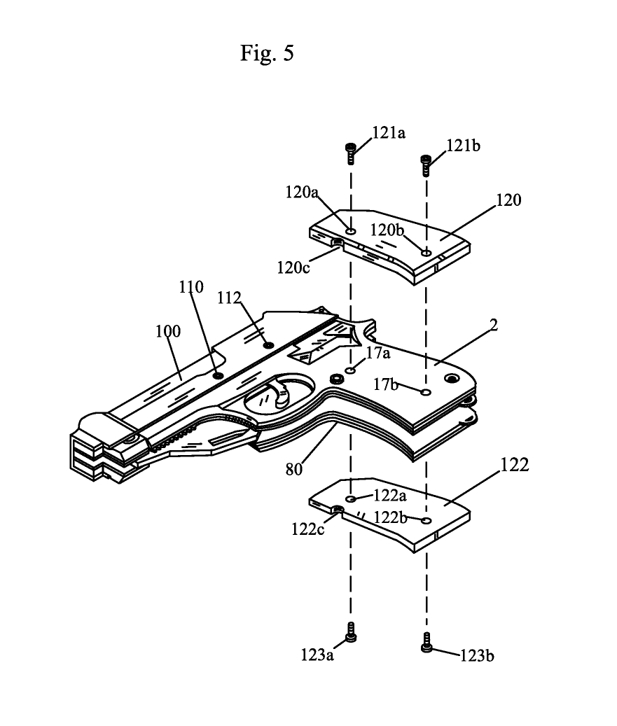

The apparatus 1 may be a folding knife which is in the form of a replica of a hand gun. The apparatus 1 includes an outer plate 2, an inner plate 20, a blade device 40, an inner plate 60, and an outer plate 80 shown in FIG. 2. The apparatus 1 may also include a sliding device 100 shown in FIG. 3, and first and second handle devices shown in FIG. 5.

Referring to FIG. 2, the outer plate 2, the inner plate 20, the blade device 40, the inner plate 60, and the outer plate 80 are connected together by a pin 19a. The pin 19a includes a cap portion 19c and a stem portion 19b. The cap portion 19c and the stem portion 19b are cylindrical shaped; and the cap portion 19c has a larger diameter than the stem portion 19b. The stem portion 19b is inserted into a circular opening 8 of the outer plate 2, into a circular opening 26 of the inner plate 20, through a washer 59a, through a circular opening 56 of the blade device 40, through a washer 59b, through a circular opening 66 of inner plate 60, through a circular opening 84 of outer plate 80 and then the stem portion 19b is fixed to the screw or bolt 99a. The stem portion 19b has a hollow inner threaded tube or chamber into which the screw or bolt 99a is configured to be inserted and screwed into to fix the screw 99a to the stem portion 19b. The screw 99a has a cap portion which has a diameter which is larger than the diameter of opening 84 and which therefore does not pass through the opening 84. The cap portion 19c of the pin 19a has a diameter which is larger than the diameter of the opening 8 and which therefore does not pass through the opening 8. The washers 59a and 59b help the blade device 40 to rotate smoothly about the stem 19b of pivot pin 19a with respect to the inner plates 20 and 60, and the outer plates 2 and 80, and while the plates 2, 20, 60, and 80, remain stationary.

The outer plate 2, the inner plate 20, the inner plate 60, and the outer plate 80 are also fixed together by screw 15, post 57a, and screw 99b shown in FIG. 2. The screw 15 has a stem portion which passes through circular opening 12 of outer plate 2, and circular opening 34 of inner plate 20, and then is screwed into one end of post 57a. Post 57a is a hollow tube including inner threads on both ends. Post 57a is a cylinder which has an outer diameter which is larger than the diameters of opening 12 of outer plate 2, opening 34 of inner plate 20, opening 65 of inner plate 60, and opening 92 of outer plate 80. Post 57a provides spacing between inner plates 20 and 60 for movement of the blade device 40. Screw 99b has a stem portion which is inserted through opening 92 in outer plate 80, through circular opening 65 in inner plate 60, and into an end of post 57a which is opposite the end into which stem portion of screw 15 is inserted.

Similarly, the outer plate 2, the inner plate 20, the inner plate 60, and the outer plate 80 are also fixed together by screw 13, post 57b, and screw 99c shown in FIG. 2. The screw 13 has a stem portion which passes through circular opening 18 of outer plate 2, and circular opening 38 of inner plate 20, and then is screwed into one end of post 57b. Post 57a is a hollow tube including inner threads on both ends. Post 57b is a cylinder which has an outer diameter which is larger than the diameters of opening 18 of outer plate 2, opening 38 of inner plate 20, opening 71 of inner plate 60, and opening 85 of outer plate 80. Post 57b, is typically identical to post 57a, and also provides spacing between inner plates 20 and 60 for movement of the blade device 40. Screw 99c has a stem portion which is inserted through opening 85 in outer plate 80, through circular opening 71 in inner plate 60, and into an end of post 57b which is opposite the end into which stem portion of screw 13 is inserted.

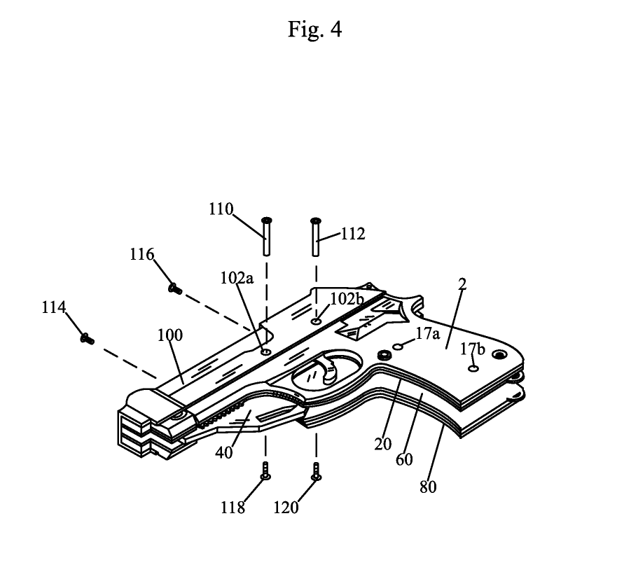

FIG. 3 shows a right, front, and bottom perspective view of the components shown in FIG. 2 assembled together, and the sliding device 100. FIG. 4 shows a right, front, and bottom perspective view of the sliding device 100 placed atop the components of FIG. 2, and with various fasteners for connecting the sliding device 100 to the components of FIG. 2. The sliding device 100 is connected to the components shown in FIGS. 3 and 4 by posts 110, 112, and screws 118 and 120. Each of the posts 110 and 112 include a cap portion having a diameter which is greater than the diameter of openings 102a and 102b. Each of the posts 110 and 112 include elongated stem portions, in the form of hollow tubes having inner threads. The elongated stem portion of post 110 is inserted through circular opening 102a, through slot 6 of outer plate 2 shown in FIG. 2, through slot 30 of inner plate 20, through slot 63 of inner plate 60, through slot 88 of outer plate 80, and then the screw 118 is screwed into a hollow tube of the stem portion of post 110 at the end opposite the cap portion of 110. Similarly, the elongated stem portion of post 112 is inserted through circular opening 102b shown in FIG. 4, through slot 6 of outer plate 2 shown in FIG. 2, through slot 30 of inner plate 20, through slot 63 of inner plate 60, through slot 88 of outer plate 80, and then the screw 120 shown in FIG. 4, is screwed into a hollow tube of the stem portion of post 112 at the end opposite the cap portion of post 112.

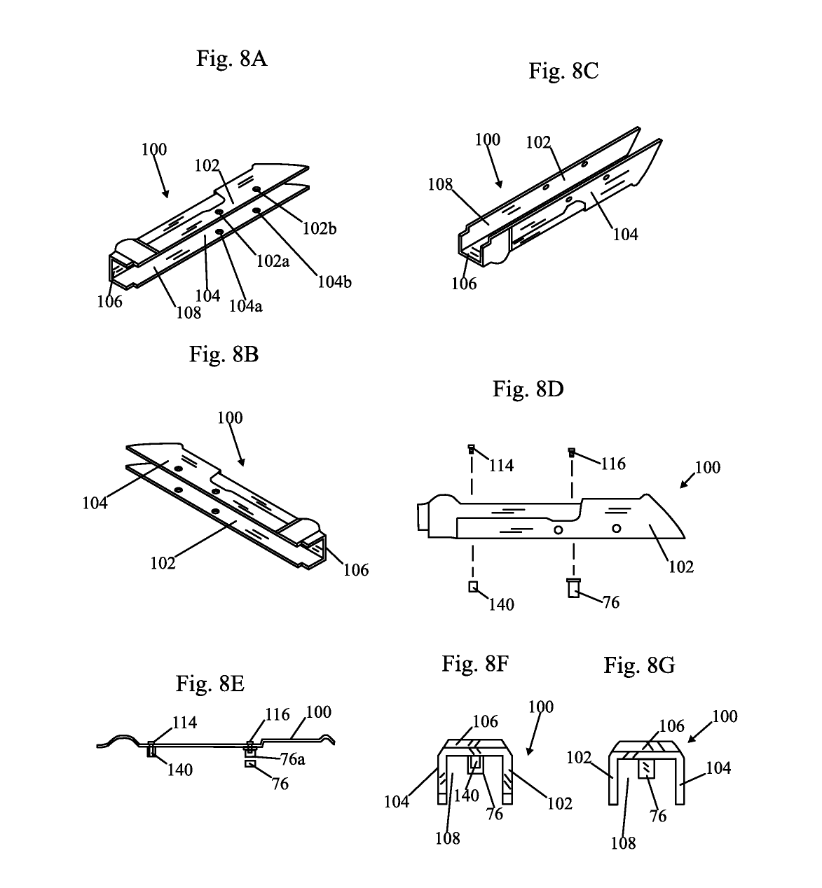

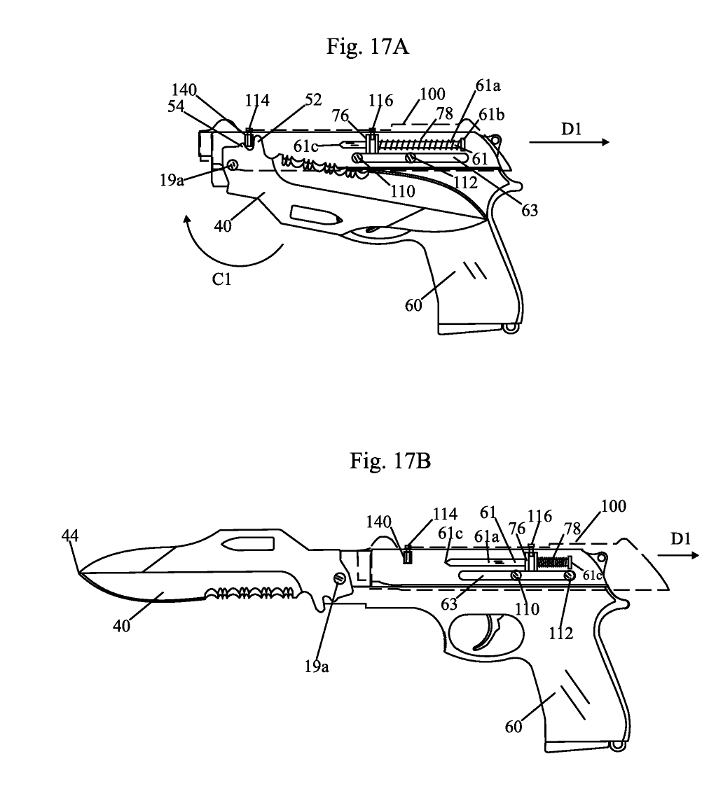

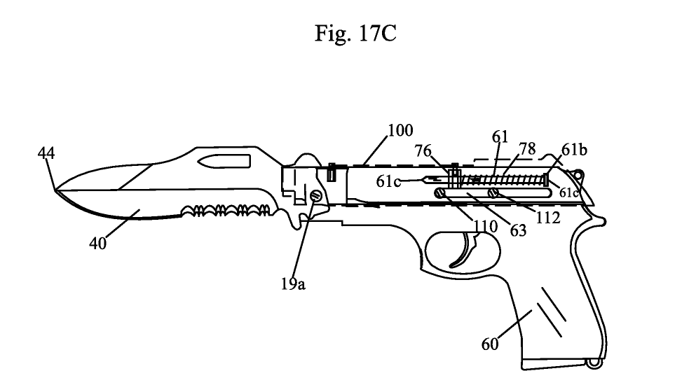

A screw 114 shown in FIG. 4 is inserted through an opening in the top of sliding device 100 and screwed into a post 140, as shown in FIGS. 8D-F, and 17A. The post 140 is inserted between portions 52 and 52 of blade device 40 as shown in FIG. 17A and is used to open or expand the blade device 40. A screw 116 is inserted through an opening in the top of the sliding device 100 and screwn into a post or device 76, as shown in FIGS. 8E-F, and 17A. The post or device 76 is used to compress a spring 78 for changing the apparatus 1 from a state where the blade device 40 is closed or retracted as in FIG. 17A to a state where the blade device 40 is opened or expanded as in FIG. 17B.

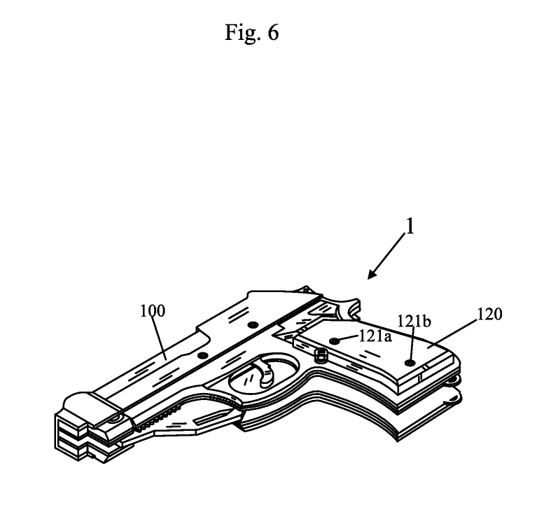

FIG. 5 shows a right, front, and bottom perspective view of the components of FIG. 2 assembled together with the sliding device 100 of FIG. 3, together with first and second handle devices 120 and 122, and with screws 121a, 121b, 123a, 123b. The screws 121a and 121b have stem portions which can be inserted into openings 120a and 120b and screwed into threaded openings 17a and 17b, respectively, of outer plate 2 to attach the handle device 120 to the outer plate 2 as shown by FIGS. 5-6. Similarly, the screws 123a and 123b have stem portions which can be inserted into openings 122a and 122b and screwed into threaded openings 81 and 83, shown in FIG. 2, respectively, of outer plate 80 to attach the handle device 122 to the outer plate 80 as shown by FIGS. 5-6.

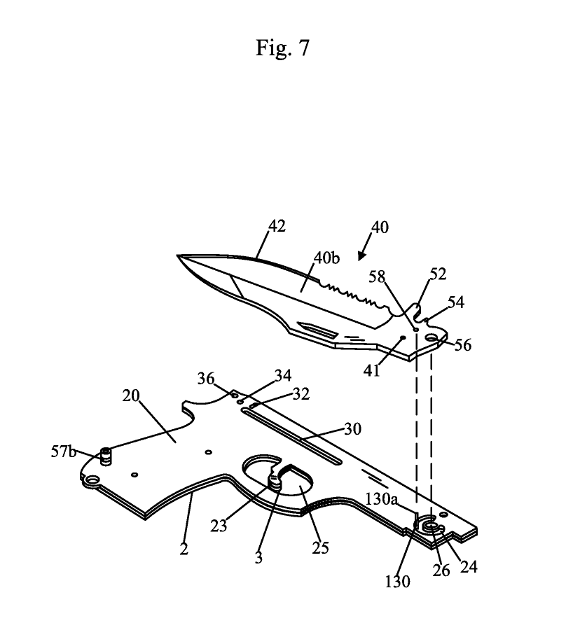

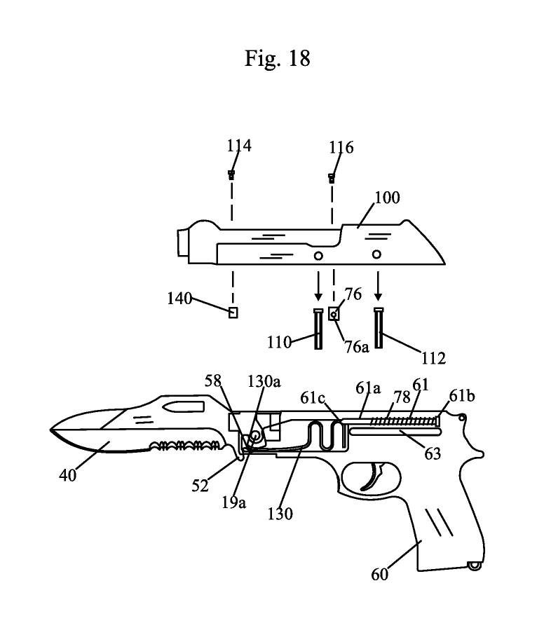

FIG. 7 shows a left, front, and bottom perspective view of the inner plate 20 connected to the outer plate 2, along with a blade device 40. FIG. 7 also shows part of the spring 130 protruding out through channel 24 of inner plate 20. The spring 130 has a point or end 130a. The point or end 130a is inserted into opening 58 of the blade device 40 in order to connect the blade device in the apparatus 1 of FIG. 1A. The spring 130 when connected to the blade device 40 by 130a being inserted through opening 58, causes the blade device 40 to spring into an open state from a closed state, when the sliding device 100 is slid as shown by FIGS. 17A-17B and 18.

FIG. 8A shows a right, front, and bottom perspective view of the sliding device 100. FIG. 8B shows a left, front, and bottom perspective view of the sliding device 100. FIG. 8C shows a left, front, and bottom perspective view of the sliding device 100. FIG. 8D shows a right side view of the sliding device 100 along with a first device or post 140 for inserting into a portion of the blade device 40 and a second device or post 76 for use with a spring device 78. FIG. 8E shows a cross sectional slice of the sliding device 100 connected to the first device or post 140 and the second device or post 76, along the line AA of FIG. 10. FIG. 8F shows a front view of the sliding device 100. FIG. 8G shows a rear view of the sliding device 100. The sliding device 100 includes a side 102, a side 104, a top 106, and a channel 108. The sliding device 100 has openings 102a and 102b and openings 104a and 104b. The screws 114 and 116 are screw into the posts 140 and 76, respectively, as shown in FIGS. 8D and 8E. The post 76 has an opening 76a into which a point 61c of the pin 61 shown in FIG. 2 is inserted when the apparatus 1 is assembled. A spring 78 is wound around a cylindrical body portion 61a of the pin 61, and a bolt head or cap portion 61b keeps one end of the spring 78 stationary on the plate 60, while the opposing end of spring 78 is moved by device or post 76. The opening 76a is configured to be too small for the spring 78 to pass through the opening 76a but large enough for the pin 61 to pass through the opening 76a, as shown in FIG. 2.

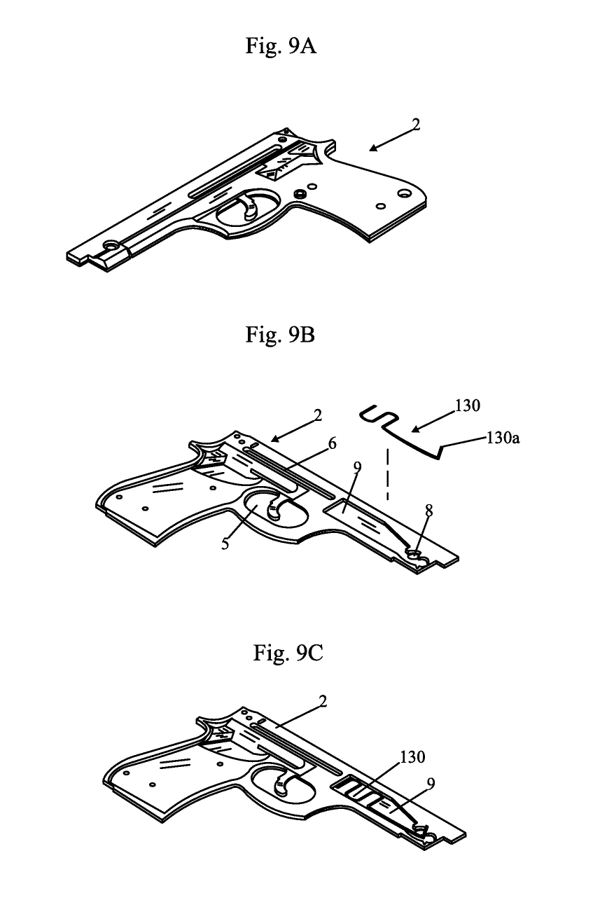

FIG. 9A shows a right, front, and bottom perspective view of the outer plate 2. FIG. 9B shows a left, front, and bottom perspective view of the first outer plate 2, along with the spring 130. FIG. 9C shows the spring 130 inserted into a recessed area 9 of the outer plate 2. The outer plate 2, as shown in FIG. 2, includes the opening 8, a ridged edge 7, an opening 5, a protrusion or fake trigger 3, the slot 6, a protruding area 10, an opening 12, a protruding circular area 16, an opening 14, a plate surface 4, openings 17a-b, and opening 18. The outer plate 2 may be made of hard metal such as steel.

FIG. 10A shows a right, front, and bottom perspective view of the inner plate 20. FIG. 10B shows a left, front, and bottom perspective view of the inner plate 20. The inner plate 20 includes an opening 26, an arc opening 24, which may less than three hundred and sixty degrees and slightly more than one hundred and eighty degrees, as shown in FIG. 2. The inner plate 20 further includes an opening 28, a ridged edge 27 which is configured to match and align with the ridged edge 7 of the outer plate 2. The inner plate 20 further includes an opening 25, a fake trigger 23, a slot 30, a slot 32, an opening 34, an opening 36, an opening 37a, a flat surface 22, an opening 37b, opening 38, and an opening 21. The inner plate 20 may be made of metal, such as steel.

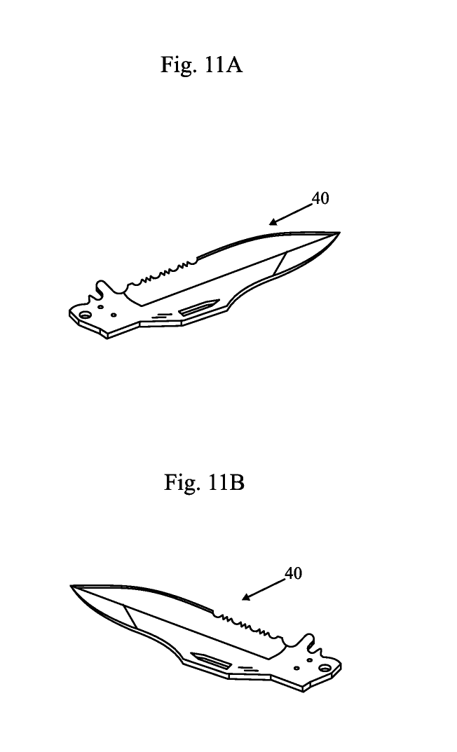

FIG. 11A shows a right, front, and bottom view of the blade device 40. FIG. 11B shows a left, front, and bottom view of the blade device 40. The blade device 40 includes a sharp edge 42 for cutting, an edge 46, which is not for cutting, which is substantially thicker than the sharp edge 42, shown in FIG. 2. The blade device 40 further includes a plurality of teeth 48, a point or end 44, a rounded protrusion 52, a sharp protrusion 54, an opening 56, an opening 58, an opening 41, and a slot 50. The blade device 40 may be made of metal, such as steel.

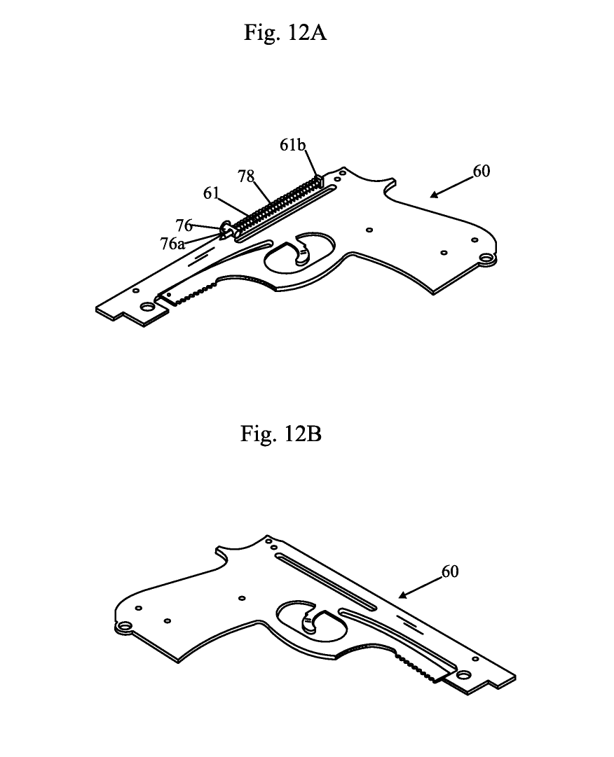

FIG. 12A shows a right, front, and bottom perspective view of the inner plate 60 along with the spring 78, pin 61, and device or post 76. The cap portion 61b of the pin 61 is fixed to the inner plate 60. When the apparatus 1 is completely assembled, the top face of the cap portion 61b shown in FIG. 12A sits in the slot 32 of the inner plate 20 shown in FIG. 7 to align the inner plates 20 and 60 and to fit the cap portion 61b compactly within the apparatus 1. The inner plate 60, as shown in FIG. 2, includes or has opening 66, opening 64, spring or leaf portion 62a separated from main portion 62b by gap 62c, which allows leaf portion 62a to spring out. The inner plate 60 includes ridged edge 72 which aligns with ridge edge 86 of outer plate 80. The inner plate 60 further includes opening 70 and protrusion or fake trigger 68. The inner plate 60 further includes slot 63, and openings 65, 67, 69, 71, 73, and 75. FIG. 12B shows a left, front, and bottom perspective view of the inner plate 60. The inner plate 60 may be made of metal, such as steel.

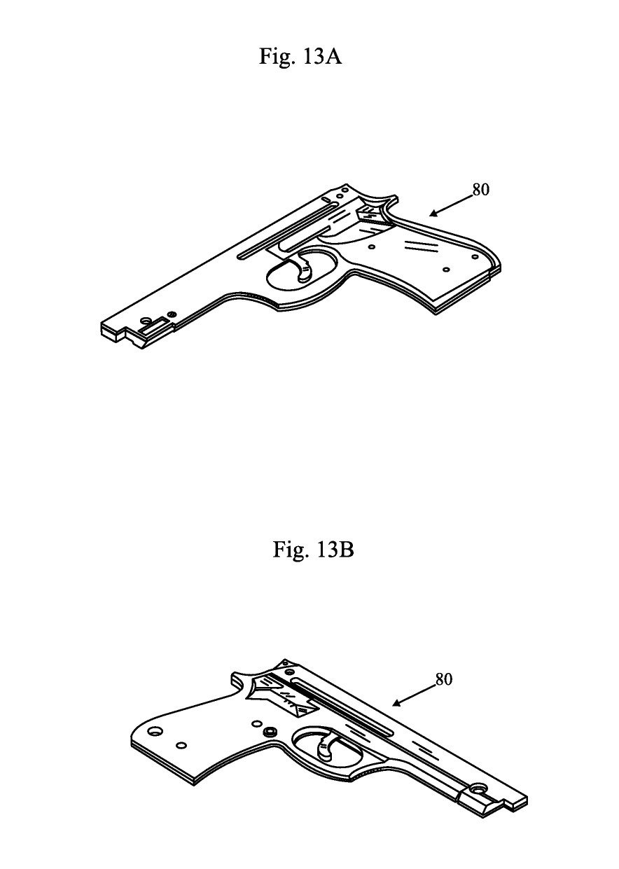

FIG. 13A shows a right, front, and bottom perspective view of the outer plate 80. FIG. 13B shows a left, front, and bottom perspective view of the outer plate 80. The outer plate 80, includes opening 84, ridged edge 86, opening 98, protrusion or fake trigger 96, slot 88, slot 90, openings 92, 94, 81, 83, and 85. The outer plate 80 further includes indented section 82. The outer plate 80 may be made of metal, such as steel.

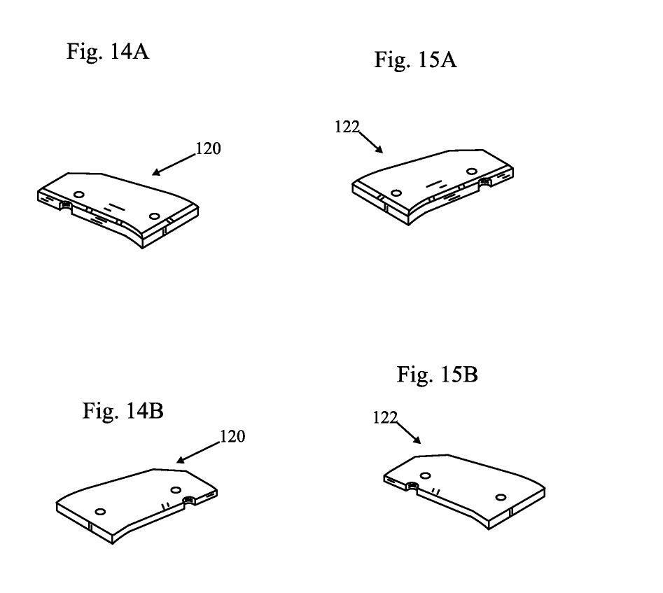

FIG. 14A shows a right, front, and bottom perspective view of the first handle device 120. FIG. 14B shows a left, front, and bottom perspective view of the first handle device 120. The handle device 120 includes openings 120a and 120b, and indented portion 120c shown in FIG. 5.

FIG. 15A shows a right, front, and bottom perspective view of the second handle device 122. FIG. 15B shows a left, front, and bottom perspective view of the second handle device 122. The second handle device 122 includes openings 122a and 122b, and indented portion 122c shown in FIG. 5.

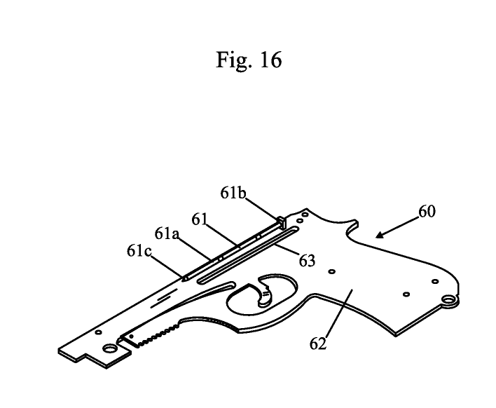

FIG. 16 shows a right, front, and bottom perspective view of the inner plate 60 and the pin 61 attached to the inner plate 60, but without the spring 78.

FIG. 17A shows a right side view of the sliding device 100 in transparent format, the blade device 40, the inner plate 60, and various other components of the apparatus 1 of FIG. 1A, in a first state, where a blade of the blade device 40 is retracted or closed. In FIG. 17A, The post 140 is between the protrusions 54 and 52 of the blade device 40. If the post 140 is not moved, then the blade device 40 cannot rotate about pivot pin 19a with respect to the plate 60. The post 140 fixed to the sliding device 100 thus prevents rotation of the blade device 40 unless the sliding device 100 is moved, which moves the post 140.

In operation, the sliding device 100 can be slid in the direction D1 shown in FIG. 17A. The causes the post 140 to be moved in the direction D1, which presses on the protrusion 52 causing the blade device 40 to rotate in the clockwise direction C1. Movement of the sliding device 100 in the direction D1 also causes the post 76 to move in the direction D1 which presses on one end of the spring 78, causing compression of the spring 78, as shown by the movement from the FIG. 17A state to the FIG. 17B state. In addition, the blade device 40 springs out quickly from the closed state of FIG. 17A to the open state of FIG. 17B as a result of the spring 130 shown in FIG. 18, which is connected to the blade device 40 by the end 130a being inserted through the opening 58. In the closed state of FIG. 17A, the spring 130 of FIG. 18, is compressed, and when the spring end 130a is rotated in the arc portion 24 shown in FIG. 7, from the state of FIG. 17A to the state of FIG. 17B, the spring 130 expands rapidly and causes the blade device 40 to rotate quickly through end 130a which is connected to blade device 40 through opening 58.

In addition, the leaf portion 62 of the plate 60 is biased in a state out of alignment and upwards from the portion 62b as shown in FIG. 2. The blade device 40 pushes down on the leaf portion 62 when the blade device 40 is in a closed state as in FIG. 17A, pushing the leaf portion into closer alignment with the portion 62b. However, when blade device 40 rotates into the open or expanded state of FIG. 17B, the blade device 40 no longer pushes down on the leaf portion 62a, which causes the leaf portion 62a to spring outwards and more out of alignment from portion 62b, and to thereby prevent the blade device 40 from rotating out of the opened state of FIG. 17B. This keeps the blade device 40 in the straightened state of FIG. 17B until and unless the leaf portion 62a is pressed back into alignment or sufficiently towards the portion 62b allowing the blade device to rotate back into the closed state and allowing the blade device 40 to again press on the leaf portion 62a.

FIG. 17B shows a right side view of the sliding device 100 in transparent format, the blade device 40, the plate 60, and various other components of the apparatus 1 of FIG. 1A, in a second state, where the blade device 40 is in an expanded or opened state, so that sharp edge 42 of the blade device 40 can be used to cut.

FIG. 17C shows a right side view of the sliding device 100 in transparent format, the blade device 40, the inner plate 60 and various other components of the apparatus 1, in a third state, where a blade of the blade device 40 is expanded or opened and the sliding device 100 has returned to its position of FIG. 17A. In at least one embodiment, the sliding device 100 stays in the position shown in FIG. 17B only as long as a force, such as a pulling force by a person's hand, is applied in the direction D1. After the force in the direction D1 is no longer applied, the sliding device 100 goes back to the position of FIG. 17A because the compressed spring 78 shown in FIG. 17B pushes the post or member 76 back in the direction opposite D1 towards the blade device 40 which causes the sliding device 100, to which the post or member 76 is attached to move back in the direction towards the blade device 40. The blade device 40 remains in the straightened, opened, or sharp edge usable for cutting position of FIG. 17C, until the leaf portion 62a shown in FIG. 2 is pushed downward, such as with a person's hand, and the blade device 40 is rotated back (about pin 19a) to its initial orientation shown in FIG. 17A.

FIG. 18 shows a right side view of the sliding device 100 separated from other components of the apparatus 1 of FIG. 1A, with the blade device 40, shown in an expanded or opened state.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a blade device having a blade with a sharp edge;
a sliding device;
a stop device; and
a housing;
wherein blade device is connected to the housing so that the blade device can rotate with respect to the housing unless prevented by the stop device;
wherein the sliding device is connected to the housing so that the sliding device can slide with respect to the housing;
and wherein when the sliding device is slid in a first direction, the blade device rotates with respect to the housing from a first state to a second state;
wherein in the first state the sharp edge of the blade device is within the housing so that the sharp edge cannot be touched by an individual holding the apparatus; and
wherein in the second state the sharp edge of the blade device is outside the housing so that the sharp edge can be touched by the individual holding the apparatus.

2. The apparatus of claim 1 further comprising
a first spring device including a spring;
and wherein the first spring device allows the sliding device to be slid in the first direction when a force is applied to the sliding device in the first direction, but causes the sliding device to slide back in a direction opposite the first direction when the force is no longer applied to the sliding device.

3. The apparatus of claim 2 further comprising
a second spring device connected to the blade device;
and wherein the second spring device causes the sharp edge of the blade device to spring out in response to sliding the sliding device in the first direction.

4. The apparatus of claim 1 wherein
the apparatus is in the shape of a gun.

5. The apparatus of claim 1 wherein
the housing includes a first plate and a second plate;
and wherein in the first state, the sharp edge of the blade device is between the first plate and the second plate.

6. The apparatus of claim 5 wherein
the stop device is part of the first plate.

7. The apparatus of claim 1 wherein
the housing includes a first inner plate, a first outer plate, a second inner plate, and a second outer plate;
and wherein in the first state, the sharp edge of the blade device is between the first inner plate and the second inner plate.

8. The apparatus of claim 7 wherein
the stop device is part of the first inner plate.

9. The apparatus of claim 1 wherein
the blade of the blade device has a notch; and
and the apparatus includes a first post which is fixed to the sliding device and inserted into the notch of the blade of the blade device in the first state, so that when the sliding device slides in the first direction, the first post contacts the blade device and causes the blade device to rotate, and causes the first post to come out of the notch of the blade.

10. A method comprising the steps of:
applying a force in a first direction to a sliding device of a folding knife apparatus to cause the sliding device to move, with respect to a housing to which the sliding device is connected, in the first direction, and to thereby cause a blade device of the folding knife apparatus to rotate, with respect to the housing, from a first state to a second state;
wherein the blade device is connected to the housing so that the blade device can rotate with respect to the housing unless prevented by a stop device;
wherein the sliding device is connected to the housing so that the sliding device can slide with respect to the housing;
wherein in the first state a sharp edge of the blade device is within the housing so that the sharp edge cannot be touched by an individual holding the apparatus; and
wherein in the second state the sharp edge of the blade device is outside the housing so that the sharp edge can be touched by the individual holding the apparatus.

11. The method of claim 10 further comprising
removing the force to allow the sliding device to slide back in a direction opposite the first direction, wherein when the force is removed the blade device remains in the second state.

12. The method of claim 10
wherein the folding knife apparatus includes a first spring device which allows the sliding device to be slid in the first direction when a force is applied to the sliding device in the first direction, but causes the sliding device to slide back in a direction opposite the first direction when the force is no longer applied to the sliding device.

13. The method of claim 11 wherein
a second spring device is connected to the blade device;
and wherein the second spring device causes the sharp edge of the blade device to spring out in response to sliding the sliding device in the first direction.

14. The method of claim 10 wherein
the folding knife apparatus is in the shape of a gun.

15. The method of claim 10 wherein
the housing includes a first plate and a second plate;
and wherein in the first state, the sharp edge of the blade device is between the first plate and the second plate.

16. The method of claim 15 wherein
the stop device is part of the first plate.

17. The method of claim 10 wherein
the housing includes a first inner plate, a first outer plate, a second inner plate, and a second outer plate;
and wherein in the first state, the sharp edge of the blade device is between the first inner plate and the second inner plate.

18. The method of claim 17 wherein
the stop device is part of the first inner plate.

19. The method of claim 10 further comprising
fixing a first post to the sliding device; and
inserting the first post into a notch of a blade of the blade device in the first state, so that when the sliding device slides in the first direction, the first post contacts the blade device and causes the blade device to rotate, and causes the first post to come out of the notch of the blade.
